(19) United States
(12) Patent Application Publication
(10) Pub. No.: US 2007/0220361 A1
(43) Pub. Date: Sep. 20, 2007

(54) Method and apparatus for guaranteeing memory bandwidth for trace data

(75) Inventors: Melissa A. Barnum, Kasson, MN (US); Lonny Lambrecht, Byron, MN (US); Tolga Ozguner, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/347,415

(22) Filed: Feb. 3, 2006

(51) Int. Cl. G06F 11/00

(52) U.S. Cl. 714/45

(57) ABSTRACT

The present invention provides a way to offload trace data from a processor and store the trace data in external memory. By accumulating trace data in large buffers and sending them to a memory interface controller, the memory interface controller may write trace data to memory as the memory interface controller would execute a normal write to memory. In this manner, no additional I/O memory pins are required and processor memory storage for trace data is kept to a minimum. Furthermore, by using a special port to the memory interface controller the writing of trace data may be accomplished in a manner that does not affect the speed of the on-chip bus between the processor and the memory interface controller.

### BACKGROUND OF THE INVENTION

1. Field of the Invention

The present invention generally relates to storing processor trace data, and more particularly, to offloading processor trace data to external memory.

2. Description of the Related Art

Computing systems often include central processing units (CPUs). CPUs execute instructions and manipulate data. Often data regarding the performance of a CPU is generated, and is sometimes referred to as trace data. Trace data is often stored for later use. One such use of trace data is to debug errors generated within the CPU. Although not limited to the following, trace data may consist of the number, rate and type of instructions executed on the CPU. Trace data may also consist of the CPU's data throughput or number of accesses to input/output (I/O) devices or memory.

CPUs usually generate large amounts of trace data. Trace data is sometimes stored in arrays located on the CPU. However, if the amount of memory on the processor assigned to trace data is limited, then only small amounts of historical trace data can be stored on the processor before it is erased to store newer trace data. This results in only small amounts of historical trace data being available to debug errors.

One solution to this problem is to increase the size of trace arrays within the processor to store trace data. However, processor real estate is expensive and therefore may be reserved for other processor functions. Therefore, large trace arrays are not a feasible solution.

Another solution to the problem is to allow access to trace data through dedicated processor I/O pins. However, increases in the number of processor pins are generally undesirable, as it adds cost.

Therefore, there is a need for an improved method and apparatus for storing processor trace data.

### SUMMARY OF THE INVENTION

The present invention generally provides a method and apparatus for storing processor trace data.

One embodiment provides a method of processing trace data indicative of one or more performance parameters of a processing device. The method generally includes generating trace data on the processor; accumulating the trace data in a buffer on the processing device, and offloading the trace data to external memory utilizing a memory interface on the processor also used to process write commands issued by an embedded processor on processing device.

Another embodiment provides a processing device generally including an embedded processor and trace data logic. The trace data logic is generally configured to store trace data indicative of one or more performance parameters of the processing device in one or more trace data buffers, and to offload accumulated trace data to external memory and issue write commands received from the embedded processor to the external memory.

Another embodiment provides a system generally including external memory and a processing device. The processing device generally includes trace data logic and memory interface controller logic. The trace data logic is generally configured to accumulate trace data indicative of one or more performance parameters of the processing device in one or more trace buffers. The memory interface controller logic is generally configured to offload the trace data to external memory utilizing write commands that target a range of the external memory allocated as offload space for the trace data.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating an exemplary computing environment, according to one embodiment of the invention.

FIG. 2 is block diagram illustrating a buffer for storing trace data, according to one embodiment of the invention.

FIG. 3 is a flowchart illustrating a method of buffering trace data and sending the buffered data to memory, according to one embodiment of the invention.

FIG. 4 is a block diagram illustrating a block of trace data within system memory, according to one embodiment of the invention.

### DETAILED DESCRIPTION OF THE PREFERRED EMBODIMENTS

The present invention provides a way to offload trace data from a processor and store the trace data in external memory. By accumulating trace data in large buffers and sending them to a memory interface controller, the memory interface controller may write trace data to memory as the memory interface controller would execute a normal write to memory. In this manner, no additional I/O memory pins are required and processor memory storage for trace data is kept to a minimum. Furthermore, by using a special port to the memory interface controller the writing of trace data may be accomplished in a manner that does not affect the speed of the on-chip bus between the processor and the memory interface controller.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### An Exemplary System

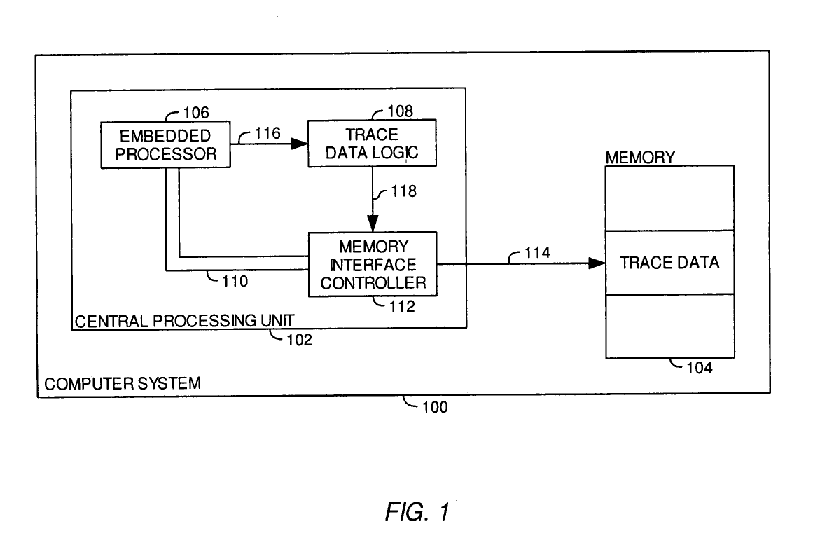

FIG. 1 is a block diagram illustrating an exemplary computer system 100. In one embodiment, the computer system 100 may be a personal computer or gaming system. Within the computer system 100 may be a central processing unit (CPU) 102 for performing processing tasks. Also within the computer system 100 may be memory 104 for storing data, and a system bus 114 for transferring data between the CPU 102 and memory 104. Memory 104 may be any device which the CPU 102 may read data from and write data to. For example, memory 104 may include, but is not limited to, hard disks, compact disks, floppy disks, and random access memory (RAM). Within the CPU 102 may be a memory interface controller (MIC) 112 which controls CPU 102 access to the system bus 114 and system memory 104.

Within the CPU 102 may be an embedded processor 106 for executing instructions or commands ready for processing. The embedded processor 106 may be connected to the memory interface controller 112 via an on-chip data bus 110. The on-chip data bus 110 may be used to move data between the embedded processor 106 and the memory interface controller 112.

Trace data logic 108 within the CPU 102 may generate data in relation to the commands that were executed or are being executed by the embedded processor 106. This data may include, but is not limited to, the type of instructions being processed and the rate of instruction processing. Trace data may also include I/O and memory accesses by the CPU 102. The trace data logic 108 may have a separate connection 116 to the embedded processor 106, other than through the on-chip data bus 110.

The trace data logic 108 may also be connected to the memory interface controller 112. The rate of data transfer between the trace data logic 108 and the memory interface controller 112 may be different than the rate of data transfer on the on-chip bus 110. According to one embodiment of the invention. In order to prevent the transfer speed of the trace data logic 108 from interfering with on-chip data bus 110 speeds, the physical connection between the memory interface controller 112 and the trace data logic 108 may be different than the on-chip data bus 110 connection to the memory interface controller 112. This different physical connection between the memory interface controller 112 and the trace data logic 108 may be referred to as a side port 118.

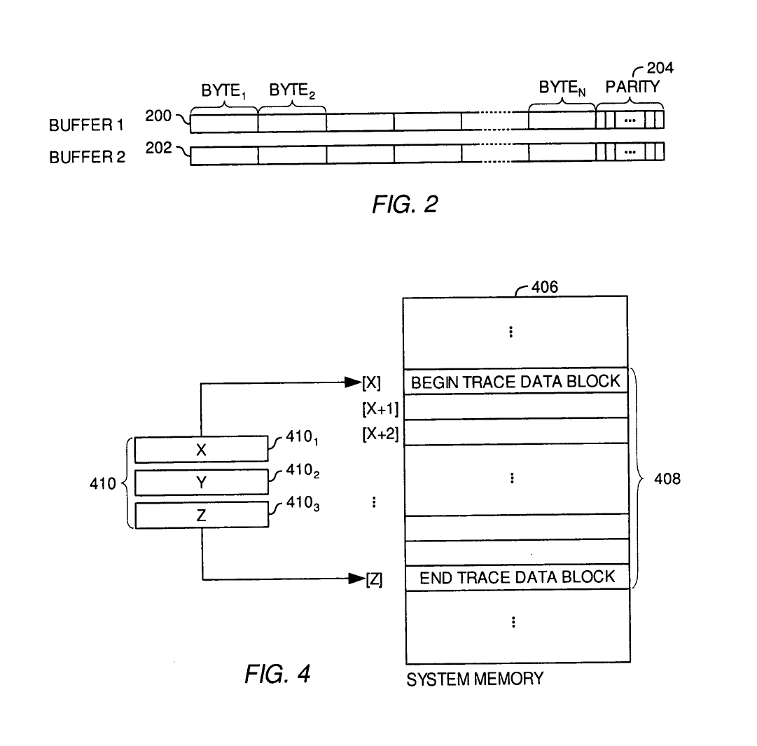

According to one embodiment of the invention, when the trace data logic 108 has received or generated trace data, the data is sent, via the side port 118, to the memory interface controller 112. The memory interface controller 112 may then place the trace data into a trace data buffer. The trace data logic 108 may continue to send trace data to the memory interface controller 112 as trace data is generated. A trace data buffer for holding trace data within the memory interface controller 112 is described in greater detail below with reference to FIG. 2.

Once enough trace data has been received in the memory interface controller, the memory interface controller 112 may construct a write command. The memory interface controller 112 may also append or attach the trace data with a memory address. The memory address may be a virtual memory address corresponding to a physical location within memory 104. The constructed write command including the associated memory address may then be placed into a conventional write command queue within the memory interface controller 112 where other non-trace data related write commands may be awaiting execution. Thus, a portion of the bandwidth of the write commands that the memory interface controller 112 issues is guaranteed to be for writing trace data from the processor to memory. The memory address used to specify where trace data may be written in memory is discussed more in FIG. 4.

In another embodiment of the invention, the write command may be constructed, with trace data and a memory address, within the trace data logic 108. Once a complete write command has been constructed by the trace data logic 108, the write command may be sent, via the side port 118, to the memory interface controller 112. The memory interface controller 112 may then place the write command into a command queue. In this manner, the memory controller may receive and process commands to write trace data out to memory, just as it would receive write commands to write modified cache lines out to memory.

The memory interface controller 112 may include arbitration logic configured to determine when a write command containing trace data will be written to memory 104. This arbitration logic may coordinate the scheduling of write commands containing trace data with other write commands and read commands (received from the processor).

For some embodiments, this arbitration logic may be configured to ensure that trace data is written out often enough to prevent the loss of trace data (e.g., by overwriting the trace data buffer). For some embodiments, the arbitration logic may accomplish this by setting a predetermined rate at which write commands within the write command queue must be written to memory 104. For some embodiments of the invention, the memory interface controller 112 may also have a setting indicating a predetermined (threshold) number of write commands are in the command queue. If the threshold number of commands within the command queue is exceeded, the arbitration logic may be forced to process write commands (e.g., giving them a higher priority than read commands) from the command queue. In an effort to ensure that trace data is not lost, this write threshold may be set relatively low. In this manner, trace data when sent from the trace buffer will be written from the write command queue more often than if the write threshold were set to a higher number of commands. The ultimate threshold number and/or rate at which write commands are processed may depend, in some cases, on the size of total trace data buffer storage space.

An Exemplary Data Buffer

FIG. 2 is block diagram illustrating buffers for storing trace data, according to one embodiment of the invention. As trace data is generated and sent by the trace data logic 108 to the memory interface controller 112, it may be stored temporarily in a trace buffer within the memory interface controller 112. A trace buffer 108 may be able to store many bytes of trace data before becoming full.

Trace data may be temporarily stored in a first trace buffer 200. Once enough trace data has been generated to fill the buffer 200 with data, the memory interface controller may construct a write command by appending or attaching the destination memory address. In one embodiment of the invention, the trace data logic 108 may also generate parity 204, and attach or append it to the trace data within the trace data buffer. The parity 204 may enable system logic or software to check the integrity of the trace data once it is received by the other system logic or software. The newly constructed trace data command holding the trace data, its destination memory address, and corresponding parity 204 may then be placed into a write command queue, where it will stay until written to memory.

Alternatively, in another embodiment of the invention, parity may be generated on a byte-by-byte basis as it is received by the memory interface controller and placed into the trace data buffer.

As operations on the trace data within the first trace buffer 200 are being carried out (generating parity, attaching or appending an address, etc.), new trace data may be stored in the second trace buffer 202. Once the second trace buffer 202 is full of data, the memory interface controller may construct a second write command, generate parity, append or attach the destination memory address, and place the second write command into the command queue. The memory interface controller 112 may then begin to fill the first trace buffer 200 with trace data. By alternating between the first and second buffers, no trace data is lost during the time it takes to generate the write command and write the data to memory.

In one embodiment of the invention, a trace data buffer may be 128 bytes long; however, other embodiments of the invention may utilize buffers of a different length. The size of the trace data buffer may be selected to correspond to the size of cachelines of the processor. When a trace data buffer is full, “cacheline” sized blocks of trace data may be incorporated into write commands (targeting some portion of memory allocated to offloading trace data) and offloaded to memory by the memory controller in the same manner as writing modified cache lines (from a processor cache) to main memory.

### Exemplary Operations

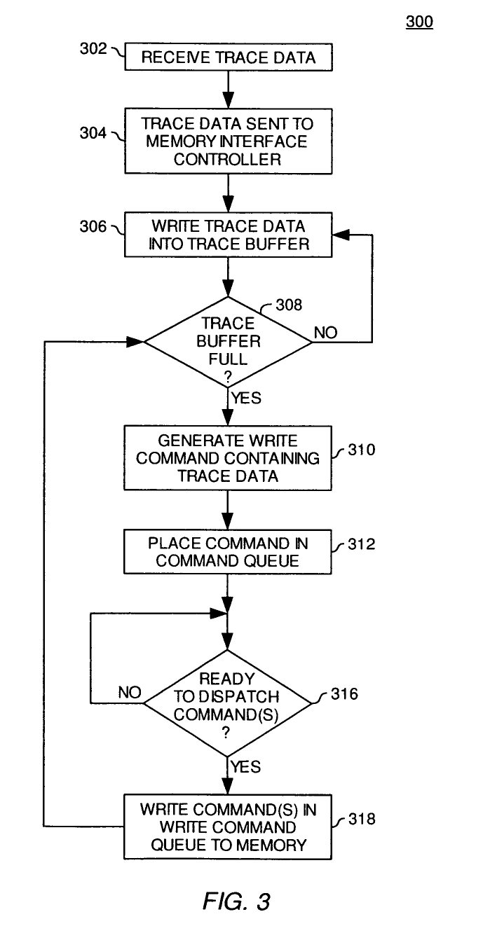

FIG. 3 is a flowchart illustrating operations 300 that may be performed by CPU 102 logic to store trace data to memory 104, according to one embodiment of the invention. The operations may be performed by the trace data logic 108, the memory interface controller logic 112, or both.

The operations 300 may begin at step 302 when trace data is received in the trace data logic 108. Next, at step 304, the trace data logic 108 may send the trace data to the memory interface controller 112 via the side port 118. The memory interface controller 112 may next write the trace data into a trace buffer at step 306. The memory interface controller 112 may then perform operations at step 308 to determine if the trace buffer is full of trace data. If not, the memory interface controller 112 will continue to write trace data into the write buffer at step 306. However, if the trace buffer is full, then the memory interface controller 112 may generate a write command at step 310. This step may consist of generating parity for the trace data within the trace buffer and attaching or appending a memory address to the trace data. Next the memory interface controller 112 may place the constructed write command into the write command queue at step 312.

After the write command containing the trace data is placed into the write command queue, logic within the memory interface controller 112 may determine when write commands within the write command queue should be written to memory (step 316). The write command will wait in the command queue until it is ready to be dispatched to memory. If the memory interface controller 112 selects the write command containing the trace data in the write command queue, the trace data is written to memory at step 318. After step 318, the memory interface controller 112 may return to step 308 to determine if the write buffer is full.

### An Exemplary Trace Data Block

FIG. 4 is a block diagram illustrating a block of trace data 408 within memory 406, according to one embodiment of the invention. Memory 406 in FIG. 4 may be one embodiment of memory 104 in FIG. 1. In one embodiment of the invention, memory address information regarding the location of trace data within memory 406 may be specified in address registers 410 located within the CPU 102. For some embodiments of the invention, the address registers indicating the location in memory 406 to store trace data may be written to by software.

In one embodiment of the invention, three address registers 410 may be utilized to write trace data to memory. One address register (410₁) may contain an address within memory 406 where the memory interface controller 112 may begin to write trace data. As mentioned above, the memory address specified in the address registers may be a virtual address corresponding to a physical address within memory 406. The second address register (410₂) may contain an address register that contains the current address within memory 406 to which new trace data may be written. This address register (410₂) may be incremented (e.g., [X+1], [X+2], etc. . . . where X is the buffer size), by the memory interface controller 112 as trace data is written to memory 406. Updating this address register (410₂) may ensure that new trace data is written to memory 406 without writing over older trace data. The third address register (410₃) may contain an address within memory 406 where the memory interface should stop writing trace data.

Alternatively, in another embodiment of the invention, the address registers may specify a beginning address and a range of addresses to be used to determine when all of the memory has been written to.

Once the memory interface controller 112 has written to all of the memory addresses in memory 406 specified by the address registers 410 including the ending address 410₃, the memory interface controller 112 may send an interrupt to the embedded processor 106, according to one embodiment of the invention. The memory interface controller 112 may then stop writing trace data to memory 406.

In another embodiment of the invention, as an alternative to or after sending an interrupt to the embedded processor 106 the memory interface controller may “loop back” to the first address (410₁). The memory interface controller 112 may then write the most recently received trace data over old trace data stored in memory 406 at the first address (410₁). The memory interface controller 112 may continue to write over old trace data in memory 406 by incrementing the address (e.g., [X+1], [X+2], etc. . . . where X is the buffer size) in order to write trace data to memory 406 without writing over the trace data just written to memory 406.

### CONCLUSION

By buffering trace data and using pre-existing write command queues located within a memory interface controller, memory trace data may be written to memory. By writing trace data to memory through the use of a memory interface controller, large amounts of trace data may be stored for later use without sacrificing processor real estate or processor I/O throughput. Furthermore, by utilizing a side port of the memory interface controller trace data storage processes will not interfere with on-chip data bus speeds.

While the foregoing is directed to embodiments of the present invention, other and further embodiments of the invention may be devised without departing from the basic scope thereof, and the scope thereof is determined by the claims that follow.

What is claimed is:

1. A method of processing trace data indicative of one or more performance parameters of a processing device, comprising:
generating trace data on the processor;
accumulating the trace data in a buffer on the processing device; and
offloading the trace data to external memory utilizing a memory interface on the processor also used to process write commands issued by an embedded processor on processing device.

2. The method of claim 1, wherein accumulating the trace data comprises accumulating the trace data in a buffer and generating parity information for the accumulate trace data.

3. The method of claim 1, further comprising generating write commands containing the trace data to be scheduled for execution by the memory interface.

4. The method of claim 1, wherein the trace data is offloaded to a range of memory locations specified by one or more registers on the processor.

5. The method of claim 5, wherein contents of the one or more registers define an offload space comprising a start address and at least one of an end address and a range.

6. The method of claim 5, further comprising generating an interrupt in response to detecting the offload space has been filled with trace data.

7. A processing device, comprising:
an embedded processor;
trace data logic to store trace data indicative of one or more performance parameters of the processing device in one or more trace data buffers; and
memory interface controller logic to offload accumulated trace data to external memory and issue write commands received from the embedded processor to the external memory.

8. The processing device of claim 7, wherein the memory interface controller logic is configured to offload blocks of trace data to external memory, wherein the blocks of trace data are equal in size to cache lines utilized by the embedded processor.

9. The processing device of claim 7, wherein the memory interface controller logic is configured to offload trace data to external memory in write commands containing the trace data.

10. The processing device of claim 7, further comprising one or more registers used to specify an offload space comprising a range of external memory locations for offloading the trace data.

11. The processing device of claim 7, wherein the memory interface controller logic is further configured to generate an interrupt once the offload space has been filled with trace data.

12. The processing device of claim 7, wherein:
the memory interface controller logic comprises a command queue; and
the memory interface controller is configured to modify the manner in which it issues write commands in response to detecting a threshold number of write commands that are in the command queue in an effort to prevent the loss of trace data.

13. The processing device of claim 7, further comprising a side port to transfer trace data from the trace buffers to the memory interface controller logic.

14. A system comprising:
external memory; and
a processing device comprising trace data logic to accumulate trace data indicative of one or more performance parameters of the processing device in one or more trace buffers and memory interface controller logic to offload the trace data to external memory utilizing write commands that target a range of the external memory allocated as offload space for the trace data.

15. The system of claim 13, wherein the memory interface controller logic is further configured to accumulate trace data with parity in blocks of data equal in size to cachelines utilized by the processing device.

16. The system of claim 13, wherein the memory interface controller logic is configured to offload trace data contained in write commands targeting memory location in the offload space.

17. The system of claim 13, further comprising one or more registers used to specify the location and size of the offload space.

18. The system of claim 17, wherein the one or more registers comprise registers to hold a start address of the offload space and at least one of an end address and a range.

19. The system of claim 13, wherein the memory interface controller logic is configured to generate an interrupt if the offload space is filled with trace data.

20. The system of claim 13, wherein the memory interface controller logic comprises arbiter logic to schedule the issuance of write commands containing trace data with read and write commands received from the processing device.
